(19) United States
(12) Patent Application Publication
(10) Pub. No.: US 2024/0128542 A1
(43) Pub. Date: Apr. 18, 2024

(54) BATTERY PACK

(71) Applicant: ZHUHAI COSMX POWER BATTERY CO., LTD., Zhuhai (CN)

(72) Inventors: Zhiguo ZHANG, Zhuhai (CN); Xuping ZOU, Zhuhai (CN); Jiafan WU, Zhuhai (CN); Jie LI, Zhuhai (CN); Changquan LIN, Zhuhai (CN)

(73) Assignee: ZHUHAI COSMX POWER BATTERY CO., LTD., Zhuhai (CN)

(21) Appl. No.: 18/399,479

(22) Filed: Dec. 28, 2023

Related U.S. Application Data
(63) Continuation of application No. PCT/CN2022/108961, filed on Jul. 29, 2022.

(30) Foreign Application Priority Data
Jul. 14, 2021 (CN) 202110797860.2

(51) Int. Cl. H01M 10/6556; H01M 10/42; H01M 10/625; H01M 10/647; H01M 10/6551; H01M 10/6555; H01M 10/658; H01M 50/211; H01M 50/505

(52) U.S. Cl. CPC H01M 10/6556; H01M 10/425; H01M 10/625; H01M 10/647; H01M 10/6551; H01M 10/6555; H01M 10/658; H01M 50/211; H01M 50/505; H01M 2010/4271; H01M 2220/20

(57) ABSTRACT

A battery pack includes a battery body, a housing, and a heat sink. The housing surrounds a part of the surface of the battery body. The heat sink is disposed on the housing. A bottom surface of the heat sink abuts against a bus board disposed on the upper end of the battery body, and the heat sink is in thermal contact with a module electrode at the upper end of the battery body. In the battery pack provided by the present application, heat dissipation around the battery body could be achieved, heat generated by a tab or heat conducted by the battery body to the tab could also be guided outwards, so that all-round heat dissipation around the battery pack is achieved. The battery pack provided by the present application is suitable for the unmanned aerial vehicle and meets the high heat dissipation requirement.

### CROSS-REFERENCE TO RELATED APPLICATIONS

The present disclosure is a continuation of International Application No. PCT/CN2022/108961, filed on Jul. 29, 2022, which claims priority to Chinese Patent Application No. 202110797860.2, filed on Jul. 14, 2021. The disclosures of the aforementioned applications are hereby incorporated by reference in their entireties.

### TECHNICAL FIELD

The present application relates to the field of the battery heat dissipation technology, and in particular, to a battery pack.

### BACKGROUND

An unmanned aerial vehicle plays a more and more important role in fields of aerial photography, agriculture, measurement, monitoring, disaster rescue, and the like. The unmanned aerial vehicle uses a lithium-ion battery pack as energy supply, so the endurance capability of the battery pack directly affects the flight time of the unmanned aerial vehicle. In order to achieve a long flight time, the unmanned aerial vehicle is usually provided with a plurality of batteries which have large capacity. Generally, a plurality of battery modules is connected in series and in parallel to achieve the requirement of large capability.

In the flight of the unmanned aerial vehicle, a high-power working condition inevitably occurs, for example, the unmanned aerial vehicle operates in a full-load state for a long time, which causes the battery pack to face a relatively serious heating problem. That the temperature of the battery pack is higher than the normal temperature causes the service life of the battery pack is significantly reduced. An existing unmanned aerial vehicle battery has a poor performance in heat dissipation, specifically low heat dissipation efficiency, which can result in elevated battery temperature when the unmanned aerial vehicle works.

Therefore, the heat dissipation of the unmanned aerial vehicle battery becomes an urgent technical problem in the industry.

### SUMMARY

The present application provides a battery pack that be able to improve heat dissipation efficiency and improve heat dissipation performance.

In order to achieve the above purpose, the present application provides a battery pack including a battery body, a housing and a heat sink. The housing surrounds a part of the surface of the battery body. The bottom surface of the heat sink abuts against a bus board disposed on the upper end of the battery body, and the heat sink is in thermal contact with a module electrode disposed on the upper end of the battery body.

According to a battery pack provided by the present application, the housing surrounds a part of the surface of the battery body, which assists to dissipate the heat of the part of the surface. The heat sink is disposed on the housing and in thermal contact with a module electrode of the battery body to exchange heat between the heat sink and the module electrode, which enables the heat generated by the tab or heat conducted by the battery body to the tab could be guided out outwards, thereby achieving all-round heat dissipation around the battery pack, improving the heat exchange efficiency effectively between the battery pack and the external environment, improving the heat dissipation effect of the battery pack, reducing the temperature of the battery pack during working, and prolonging the service life of the battery pack. Therefore, the battery pack provided by the present application is suitable for unmanned aerial vehicles, and meets usage requirements of high-power and high-heat dissipation for the unmanned aerial vehicle.

In a possible implementation, the battery pack provided by the present application further includes a plurality of first thermally conductive pads, and the plurality of thermally conductive pads all abut between the lower surface of the bus board and the battery body.

In a possible implementation, the bus board is provided with at least one second thermally conductive pad, an upper end of the battery body is provided with a tab, and the at least one second thermally conductive pad abuts against the tab and the heat sink.

In a possible implementation, the battery body comprises at least two battery modules and at least two central thermally conductive plates correspondingly disposed on the outsides of the at least two battery modules.

In a possible implementation, the central thermally conductive plate is U-shaped, the central thermally conductive plate surrounds at least three surfaces of the battery module, and an inner surface of the central thermally conductive plate is connected with the battery module by means of a heat conductive adhesive.

In a possible implementation, the central thermally conductive plates between two adjacent battery modules in the at least two battery modules are oppositely disposed, and bottoms of the central thermally conductive plates between the two battery modules are connected by means of the heat conductive adhesive.

In a possible implementation, the battery module comprises a plurality of battery cells and a plurality of heat conduction sheets respectively corresponding to the plurality of battery cells, the plurality of battery cells are stacked abreast, each of the heat conduction sheet surrounds at least three surfaces of the corresponding battery cell, and two adjacent heat conduction sheets in the plurality of heat conduction sheets are oppositely disposed.

In a possible implementation, an elastic member is further provided between the two adjacent heat conduction sheets.

In a possible implementation, the bus board is provided with a plurality of through slots in which a plurality of the second thermally conductive pads are embedded respectively, and the plurality of the second thermally conductive pads are respectively attached to a plurality of the tabs disposed at the upper ends of the plurality of battery cells.

In a possible implementation, the battery pack further comprises an insulation plate disposed between the bus board and the heat sink, and a heat conducting medium is filled between the insulation plate and the bus board or between the insulation plate and the heat sink.

In a possible implementation, an accommodation cavity for accommodating the battery body is enclosed in the housing, and the housing comprises a bottom plate disposed below the battery body, a front plate disposed in front of the battery body, a rear plate disposed behind the battery body, and two side plates disposed on two sides of the battery body.

In a possible implementation, the bottom plate is provided with a heat dissipation fin.

In a possible implementation, at least one of the two side plates is provided with a heat dissipation fin.

In a possible implementation, the front plate is provided with a heat dissipation fin.

In a possible implementation, the rear plate is provided with a heat dissipation fin.

In a possible implementation, the heat sink is disposed on the housing, and the heat sink is provided with a plurality of ventilation holes.

In a possible implementation, the plurality of ventilation holes are in a side face of the heat sink and penetrate through two side faces of the heat sink.

In a possible implementation, at least one of the ventilation holes is provided with at least one inner fin, and the inner fin extend along the extending direction of the ventilation hole.

In a possible implementation, a top of the heat sink is provided with a concave cavity, the concave cavity is used for containing the battery management system, and a bottom of the concave cavity is adjacent to and isolated from a top of the ventilation hole.

In a possible implementation, the battery pack further comprises an upper cover disposed on the heat sink, and the upper cover is provided with an interface.

The battery pack provided by the present application provides the first thermally conductive pad that abuts between the lower surface of the bus board and the battery body, so that heat generated by the battery body could be quickly conducted upwards through the first thermally conductive pad. That the first thermally conductive pad fills the space between the battery body and the upper end of the tab reduces the thermal resistance in the space, thereby improves heat dissipation efficiency and heat dissipation performance.

The battery pack provided by the present application provides the second thermally conductive pad that abuts against the tab so that the heat generated by the battery body and conducted to the tab and the heat generated by the tab both could be conducted upwards through the second thermally conductive pad and then be dissipated to the external environment through the heat sink, thereby achieving the effect of heat dissipation and cooling of the battery pack.

In the battery pack provided by the present application, the insulation plate disposed between the bus board and the heat sink has effects of insulation and isolation, thereby improving the usage safety of the battery pack. A good heat conduction channel could be formed by filling the heat conducting medium into the gap between the bus board and the heat sink.

In the battery pack provided by the present application, the heat sink is provided with a plurality of ventilation holes. According to this configuration, air could conveniently enter the ventilation hole, especially during flight of the unmanned aerial vehicle, to accelerate the ventilation of air in the ventilation hole and take away the heat conducted to the heat sink by the module electrode, so as to improve heat dissipation effect.

In addition to the technical problems solved by the embodiments of the present application, the technical features constituting the technical solutions and the beneficial effects of the technical features of these technical solutions described above, other technical problems to be solved by the battery pack provided in the embodiments of the present application, other technical features included in the technical solutions, and the beneficial effects of these technical features will be described in further detail in specific embodiments.

### BRIEF DESCRIPTION OF THE DRAWINGS

In order to more clearly illustrate the technical solutions in the embodiments of the present application or prior art, the drawings that need to be used in the embodiments or the prior art are briefly described below, and it is obvious that the drawings in the below description are some embodiments of the present application, and as for a person having ordinary skill in the art, without any creative work, other drawings may be obtained according to these drawings.

FIG. 1 is a schematic diagram of a three-dimensional explosion structure of a battery pack according to an embodiment of this application.

FIG. 2 is a front view of FIG. 1 of a battery pack according to an embodiment of this application.

FIG. 3 is a schematic diagram of a three-dimensional structure of a battery body and a bus plate mounting state of a battery pack according to an embodiment of this application.

FIG. 4 is a schematic top view of a bus board of a battery pack according to an embodiment of this application.

FIG. 5 is a schematic diagram of a three-dimensional structure of a battery body of a battery pack according to an embodiment of this application.

FIG. 6 is a schematic diagram of a three-dimensional structure of a heat conduction sheet and a battery cell of a battery pack according to an embodiment of this application.

FIG. 7 is a schematic diagram of a three-dimensional structure of the battery cell in FIG. 6 of a battery pack according to an embodiment of this application.

FIG. 8 is a schematic diagram of a three-dimensional structure of a front plate and a rear plate of a battery pack and battery body according to an embodiment of this application.

FIG. 9 is a schematic diagram of a three-dimensional structure of a side plate of a battery pack according to an embodiment of this application.

FIG. 10 is a schematic diagram of a three-dimensional structure of a heat sink of a battery pack according to an embodiment of this application.

FIG. 11 is a schematic diagram of another three-dimensional structure of a heat sink of a battery pack according to an embodiment of this application.

### DETAILED DESCRIPTION OF THE EMBODIMENTS

In order to more clearly illustrate the purposes, the technical solutions and advantages of the present application, the technical solutions in the present application will be clearly and completely described below with reference to the drawings in the present application, and obviously, the described embodiments are part of the embodiments of the present application rather than all of the embodiments. Based on the embodiments of the present application, all other embodiments obtained by a person having ordinary skill in the art without any creative work shall fall within the protection scope of the present application.

There are two main heat sources of the battery. The first heat source is the battery body and the second heat source is the tab. The heating of the battery body is caused by an internal resistance and electrochemical reactions of the battery cell, and the heating of the tab is caused by a resistance of the tab itself. Generally, the heat generated by the battery body and the heat generated by the tab affect each other. Therefore, both the heat dissipation of the battery body and the tab should be considered when considering the heat dissipation of the battery. At the same time, thermal resistance between the heat source and cool ends should also be reduced.

Therefore, how to reasonably plan configuration and arrangement of a battery pack and design each part to reduce the working temperature of the battery pack is an important problem should be considered in the battery design process of the unmanned aerial vehicle.

In view of the above background, the battery pack provided by the present application forms the configuration facilitating heat dissipation of the battery pack on both the battery body and the tab, thereby remarkably reducing the temperature of the battery pack during working, so that the battery pack provided by the present application is suitable for unmanned aerial vehicles, and meets usage requirements of high-power and high-heat dissipation for the unmanned aerial vehicle.

The battery pack provided by this embodiment of this application is described below with reference to the accompanying drawings.

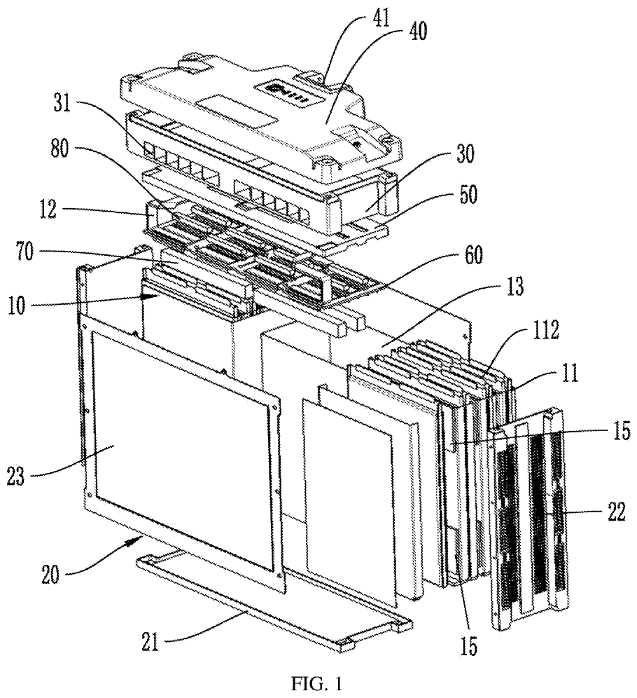

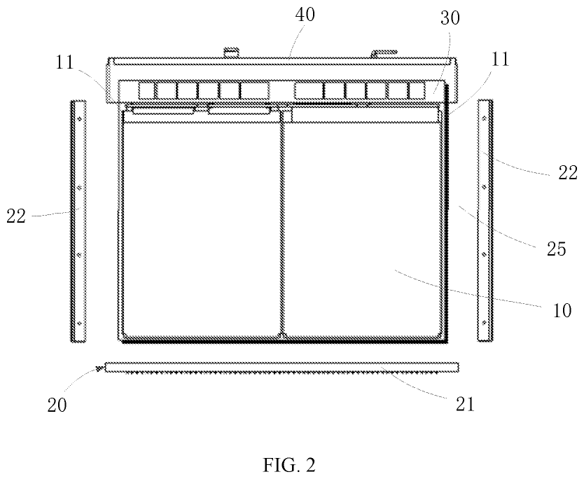

Referring to FIG. 1 and FIG. 2, the present application provides a battery pack suitable for an unmanned aerial vehicle. The battery pack provided by the present application includes: a battery body 10, a housing 20, a heat sink 30 and an upper cover 40. The housing 20 surrounds a part of the surface of the battery body 10. The heat sink 30 is disposed on the housing 20 and the bottom surface of the heat sink 30 abuts against a bus board 60 disposed on the upper end of the battery body 10. The heat sink 30 is in thermal contact with module electrodes 12 disposed on the bus board 60, namely, the heat sink 30 and the module electrodes 12 at the upper end of the battery body 10 could achieve mutual conduction of heat. The upper cover 40 is disposed on the heat sink 30 for closing the housing 20.

According to the battery pack provided by the present application, on one aspect, the housing 20 plays a role in protecting the battery body 10 and ensuring structural strength, on the other aspect, the housing 20 plays a role in heat conduction and heat dissipation for the battery body 10. In addition, the heat sink 30 is disposed on the housing 20 and in thermal contact with module electrodes 12 at the upper end of the battery body 10 and thereby could guide the heat outwards. The above setting effectively improves the heat exchange effect with the external environment and improves the heat dissipation effect of the battery pack, thereby reducing the temperature of the battery pack during working and prolonging the service life of the battery pack. The above effects enable the battery pack provided in this application to meet the high-power and high-heat dissipation requirements for unmanned aerial vehicles, and can be suitable for unmanned aerial vehicles.

The manner that the heat sink 30 is in thermal contact with the module electrodes 12 disposed on the above of the battery body 10, is not limited to the heat sink 30 being directly attached to the module electrodes 12 of the battery body 10 to exchange heat. The manner could also be that providing a second thermally conductive pad 80 having good heat conduction performance between the heat sink 30 and the module electrodes 12 of the battery body 10, which could indirectly conduct the heat between the heat sink 30 and the battery body 10 via the second thermally conductive pad 80, thereby achieving heat exchange.

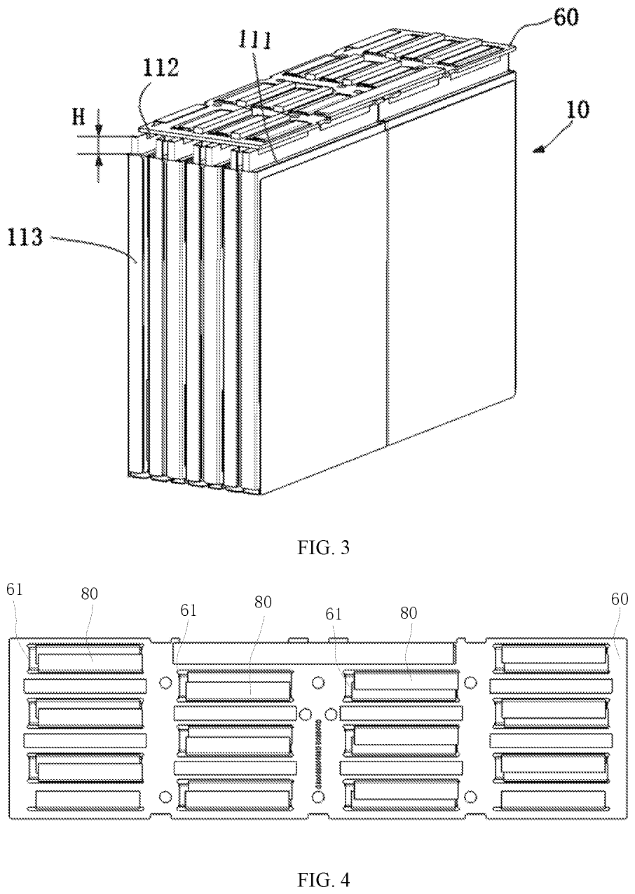

Referring to FIG. 1 and FIG. 3, the upper end of the battery body 10 is provided with the bus board 60. Limited by the structure of the battery body 10, there exists a space with a distance H from the upper edge of main body of the battery body 10 to the top end of a tab 112, thus the thermal resistance in the space with distance H should be reduced. The battery pack provided by the embodiment further includes a plurality of first thermally conductive pads 70, the plurality of first thermally conductive pads 70 abut against the lower surface of the bus board 60 and the battery body 10, so that heat generated by the battery body 10 is conducted upwards through the first thermally conductive pads 70 due to the heat conduction effect. The first thermally conductive pads 70 play a role in filling the space between the main body of battery body 10 and the top end of the tab 112, thus reducing the thermal resistance of the space where the distance H is located, and guiding the heat of the battery body 10 upwards.

In some embodiments, the bus board 60 is provided with at least one second thermally conductive pad 80. The bus board 60 is provided with through slots 61. The upper end of the battery body 10 is provided with the tab 112, the tab 112 may be inserted into the through slot 61 from below the bus board 60 and protrude from above the bus board 60 and bent to contact with a contact (such as a copper bar) on the surface of the bus board 60. The at least one second thermally conductive pad 80 abuts against the tab 112 and the heat sink 30. Heat conducted by the battery body 10 to the tab 112 and heat generated by the tab 112 is conducted upwards through the second thermally conductive pad 80, and the heat dissipation and cooling effects of the battery pack could be achieved due to the heat dissipation effect of the heat sink 30. In some embodiments, the at least one second thermally conductive pad 80 includes a plurality of second thermally conductive pads 80.

In order to improve the heat dissipation effect of heat sink 30, heat sink 30 could be made of metal, such as an aluminum material, which is good in thermal conductivity and light in mass.

Referring to FIG. 1, in a possible implementation, the battery pack provided by the embodiment further includes an insulation plate 50, the insulation plate 50 is between the bus board 60 and heat sink 30, and the insulation plate 50 is positioned above the at least one second thermally conductive pad 80. The insulation plate 50 plays a role in insulation and isolation and improves the use safety of the battery pack. The insulation plate 50 is made of a material with high heat conductivity coefficient and good insulating performance, and meanwhile, the thickness needs to be as small as possible.

It is easy to understand that the heat conducting medium is filled between the insulation plate 50 and the bus board 60, and/or, the heat conducting medium is filled between the insulation plate 50 and the heat sink 30. The heat conducting medium could directly enter a gap between the insulation plate 50 and the bus board 60. The heat conducting medium could also directly enter a gap between the insulation plate 50 and the heat sink 30. The heat conducting medium could form a good heat conduction channel between the bus board 60 and the heat sink 30, thereby avoiding obstructing and influencing the heat conduction by the disposing of the insulation plate 50.

The heat conducting medium could be heat conducting silicone grease, heat conducting paste and the like.

The main function of the heat sink 30 is taking away the heat generated by the tab 112 itself, the heat generated by the battery body 10 and conducted to the tab 112, and the heat generated by the battery cell body 10 and conducted outwards through the first thermally conductive pad 70, the second thermally conductive pad 80 and the bus board 60. A plurality of ventilation holes 31 are formed in the heat sink 30 to make air enter the ventilation holes 31 conveniently, especially in the flight of the unmanned aerial vehicle, due to the acceleration of the ventilation of air in the ventilation hole 31, it makes the heat conducted to the heat sink 30 by the module electrodes 12 is taken away and improves the heat dissipation effect.

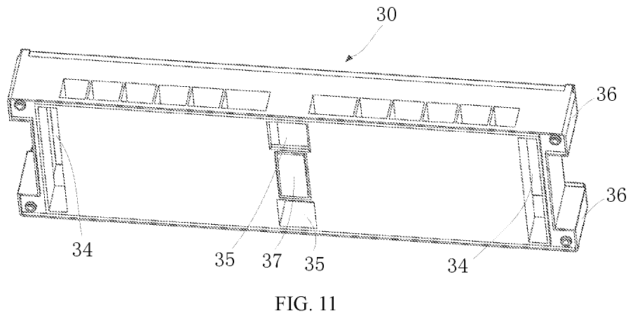

In a possible implementation, referring to FIG. 10 and FIG. 11, a plurality of ventilation holes 31 are formed in the side face of the heat sink 30. The plurality of ventilation holes 31 penetrate through the two side faces of the heat sink 30. A plurality of inner fins 32 are disposed in the plurality of ventilation holes 31. The plurality of inner fins 32 are longitudinally disposed and spaced from each other, and the upper ends and the lower ends of the plurality of inner fins 32 are connected with the inner walls of the ventilation holes 31. The inner fins 32 could effectively increase the heat dissipation area, so that the air entering the ventilation holes 31 may fully and quickly take away the heat on the heat sink 30.

The plurality of inner fins 32 extend from one end to the other end of at least one ventilation hole 31. Air entering the ventilation hole 31 could make full contact with the inner fins 32 in the ventilation process, and the heat dissipation effect is improved.

The top face of the heat sink 30 is provided with a concave cavity 33 for containing the battery management system, and the concave cavity 33 is located above the at least one ventilation hole 31 and isolated from the at least one ventilation hole 31. A pair of first preformed holes 34 are disposed in the concave cavity, the pair of first preformed holes 34 penetrate through the bottom of the concave cavity, the pair of first preformed holes 34 are isolated from the at least one ventilation hole 31. The first preformed holes 34 are used for allowing electric wires connected to the inside of the battery pack 10 to pass through, and the heat generated by the battery management system while working is also dissipated outwards through the heat sink 30. Or, the first preformed holes 34 are configured to allow the module electrodes 12 to pass through, and the heat of the module electrodes 12 could be absorbed and exported by the wall of the first preformed hole 34.

A preformed slot 37 is formed in the bottom of the heat sink 30. Second preformed holes 35 are further formed in the concave cavity 33. The preformed slot 37 is between the pair of second preformed holes 35. The second preformed holes 35 and the ventilation hole 31 are isolated from each other. The second preformed holes 35 are used for allowing a communication line connected to the inside of the battery to pass through.

The two ends of the heat sink 30 are each provided with a pair of mounting columns 36, the side walls of the pair of mounting columns 36 are connected with the two end faces of the heat sink 30, and the upper cover 40 is connected to the mounting columns 36 at the two ends of the heat sink 30 through screws.

The tabs 112 include positive electrode tabs and negative electrode tabs. The module electrodes 12 are on the bus board 60, the module electrodes 12 include a total positive electrode and a total negative electrode of the battery body 10 and are used for outputting electric energy, and the module electrodes 12 are electrically connected with the positive electrode tabs located on the battery body 10 and the negative electrode tabs located on the battery body 10.

In a possible implementation, the battery body 10 includes one battery module 11.

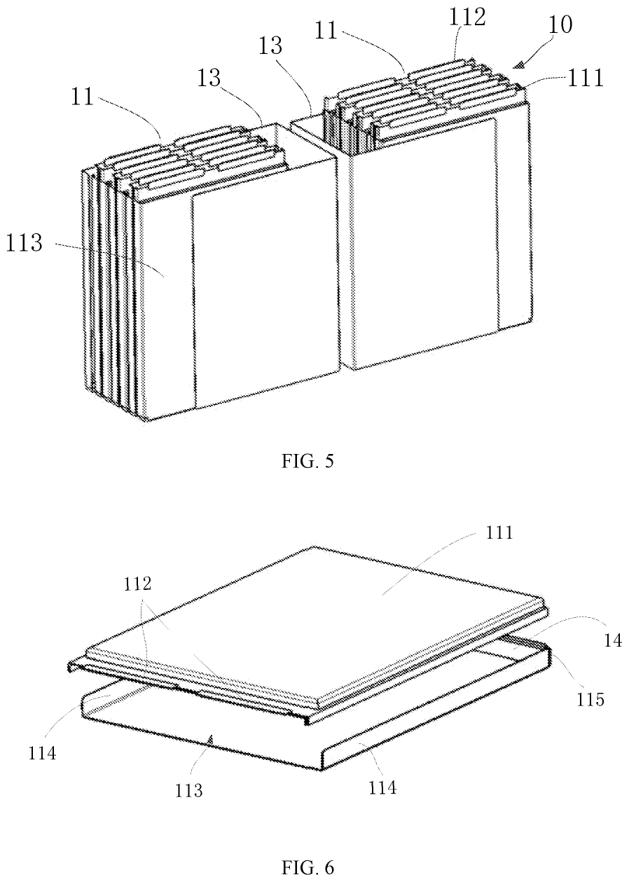

In another possible implementation, referring to FIG. 3 and FIG. 5, the battery body 10 includes at least two battery modules 11 and central thermally conductive plates 13 respectively disposed on the outer sides of the at least two battery modules 11.

In the embodiment, the battery body 10 includes two battery modules 11 and two central thermally conductive plates 13 disposed on the outer sides of the two battery modules 11 respectively. In other examples, the battery body 10 may include three battery modules 11 or more battery modules 11, which are not specifically limited here.

Referring to FIG. 3 and FIG. 5, each of the central thermally conductive plates 13 is U-shaped and surrounds at least three surfaces of the corresponding battery module 11. The hottest part of the battery pack is the inside of the battery pack, and how to conduct the heat of the inside of the battery pack to outside is a key for improving the heat dissipation effect of the battery pack. As for the U-shaped central thermally conductive plate 13, the bottom of the central thermally conductive plate 13 passes through the middle of two adjacent battery modules 11, so the heat between the two adjacent battery modules 11 may be conducted to the front surfaces and the back surfaces of the battery modules 11, so as to achieve the effect of conducting the heat of the inside of the battery pack outwards.

The inner surface of the central thermally conductive plates 13 and the battery modules 11 are respectively bonded by a heat conductive adhesive, so that the contact thermal resistance between the central thermally conductive plates 13 and the battery modules 11 is reduced, and the heat conducting effect is improved.

The central thermally conductive plates 13 of the two adjacent battery modules 10 are oppositely disposed, and the bottoms of the central thermally conductive plates 13 between the two adjacent battery modules 10 are bonded through the heat conductive adhesive, so that the heat conduction efficiency is improved. The bottom of the central thermally conductive plate 13 is an end opposite to the opening of the U-shaped central thermally conductive plate 13.

Referring to FIG. 5 and FIG. 6, each of the battery modules 11 includes a plurality of battery cells 111 and a plurality of heat conduction sheets 113 corresponding to the plurality of battery cells 111, and the plurality of battery cells 111 are stacked abreast. The plurality of battery cells 111 are connected in series, and the heat conduction sheets 113 surround the corresponding battery cells 111 at least three faces. The heat conduction sheets 113 protect the battery cells 111. The heat conduction sheets 113 could accelerate the heat dissipation speed of the battery cells 111 to accelerate the heat exchange speed between the battery cells 111 so as to achieve equal heating, to facilitate the overall temperature of the battery cells 111 to tend to be uniform, and to prevent the battery cells 111 or partial of it from overheating, which affects the overall use safety and service life of the battery modules 11.

It is easy to understand that one heat conduction sheet 113 could be disposed on the outer side of each battery cell 111. The number of the battery cells 111 of the battery module 11 may be set according to use requirements.

Referring to FIG. 6 and FIG. 7, each heat conduction sheet 113 surrounds at least three surfaces, including a side surface with the largest area surrounded by the heat conduction sheet 113 and two side surfaces connected to the surface of the side surface with the largest area, of the corresponding battery cell 111 to form heat conducting channels on at least three surfaces of the battery cell 111, which facilitates uniform overall temperature of the battery cell 111 and avoids partially overheating. When the battery cell 111 works, the position with the highest heating temperature is the center of the battery cell 111, so the heat conduction sheet 113 could also conduct the heat generated by center of the battery cell 111 outwards, which improves the heat dissipation effect.

The heat conduction sheet 113 could be adhered to the battery cell 111 by heat conduction adhesive, so that the heat conduction sheet 113 could be tightly attached to the surface of the battery cell 111, which facilitates the conduction that the heat generated by the battery cell 111 is guided outwards rapidly through the heat conduction sheet 113.

In a possible implementation, the thickness of the heat conduction sheet 113 could be in the range of 0.2 mm to 0.4 mm. The heat conduction sheet 113 could protect the battery cell 111 to some extent and improves the strength of the battery cell 111.

In a possible implementation, the two sides of the heat conduction sheet 113 connect two first bent plates 114 respectively and the bottom of the heat conduction sheet 113 connects a second bent plate 115, so that when the heat conduction sheet 113 is tightly attached to the surface of the battery cell 111, the two first bent plates 114 may be tightly attached to the two side faces of the battery cell 111 respectively. According to the configuration, heat in the center of the battery cell 111 could be conducted outwards, and the heat dissipation effect is improved.

Referring to FIG. 1, two adjacent heat conduction sheets 113 are oppositely disposed, and an elastic member 15 is disposed between two adjacent heat conduction sheets 113, so that an elastic space is reserved between the two adjacent heat conduction sheets 113, and the overall volume expansion of the battery body 10 is avoided when the battery cell 111 is heated and expands.

In a possible implementation, the elastic member 15 could be foam, heat conduction silica gel and the like.

Particularly, referring to FIG. 6, a buffer block 14 is positioned between the bottom of the battery cell 111 and the second bent plate 115 as a buffer and damping to prevent the battery pack from violent impact, influencing the service life of the battery pack, when the battery pack falls off.

In a possible implementation, the buffer block 14 could be foam, and could also be heat conducting silica gel and the like.

Referring to FIG. 1 and FIG. 4, since the thermal resistance of the bus board 60 itself is large, the bus board 60 is provided with a plurality of through slots 61, the plurality of second thermally conductive pads 80 are embedded in the plurality of through slots 61 formed in the bus board 60 respectively, and the plurality of second thermally conductive pads 80 are attached to the tabs 112 disposed at the upper ends of the plurality of battery cells 111 respectively. In this way, the thermal resistance of the bus board 60 is reduced. The second thermally conductive pad 80 is made of a material with good heat conduction performance and certain compressibility, such as heat conduction silica gel.

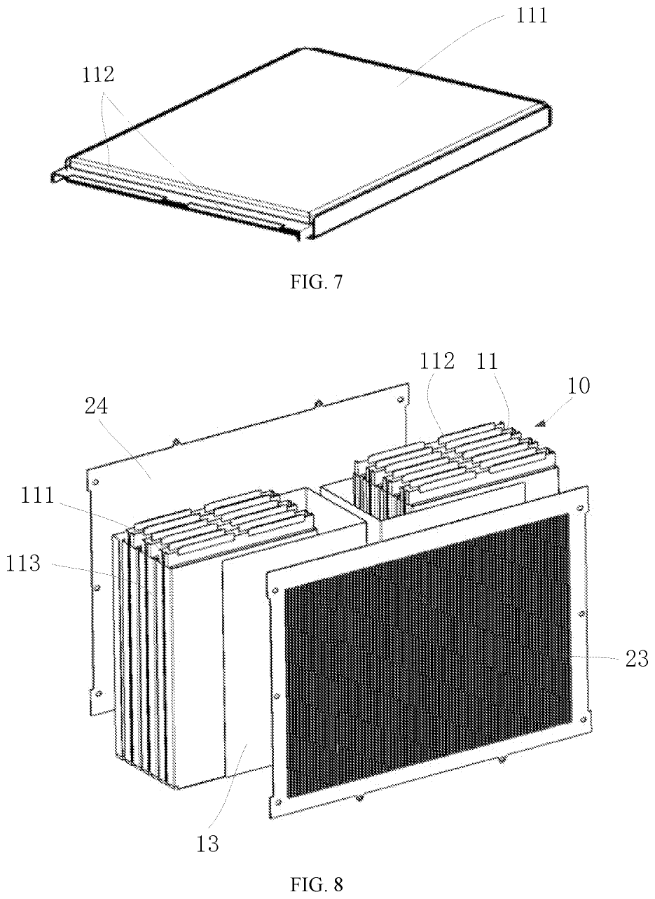

Referring to FIG. 1 and FIG. 2, an accommodation cavity 25 for accommodating the battery body 10 is enclosed in the housing 20, and the housing 20 includes: a front plate 23, a rear plate 24 and two side plates 22. Referring to FIG. 2 and FIG. 8, the bottom plate 21 is on the bottom surface of the cell body, the front plate 23 is in front of the battery body 10, the rear plate 24 is behind the battery body 10, and the two side plates 22 are respectively on two side surfaces of the battery body 10.

In a possible implementation, the bottom plate 21 is attached to the bottom surface of the battery body 10 by means of a heat conductive adhesive, the front plate 23 is attached to the front face of the battery body 10 by means of a heat conductive adhesive, the rear plate 24 is attached to the rear face of the battery body 10 by means of a heat conductive adhesive, and the two side plates 22 are respectively attached to two side faces of the battery body 10 by means of a heat conductive adhesive. Therefore, heat generated by the battery body 10 could be dissipated from the front plate 23 to the front side of the battery body 10, from the bottom plate 21 to the bottom of the battery body 10, from the rear plate 24 to the rear side of the battery body 10, and from the two side plates 22 to the two sides of the battery body 10, which result in all-around heat dissipation improvement of the heat dissipation effect of the battery body 10.

In a possible implementation, referring to FIG. 2 and FIG. 6, since the bottom surface of the battery body 10 is the lower end of the battery module 11, the bottom plate 21 is attached to the bottom surface of the battery body 10 by means of the heat conductive adhesive, namely the bottom plate 21 is attached to the second bent plate 115 of each heat conduction sheet 113 by means of the heat conductive adhesive, thereby ensuring a good thermal contact effect between the bottom plate 21 and the battery module 11, so that heat generated by the battery cell 111 could be conducted to the bottom plate 21 through the second bent plate 115 of the heat conduction sheet 113, so as to be dissipated.

In a possible implementation, referring to FIG. 1 and FIG. 8, the front plate 23 is attached to the central thermally conductive plates 13 of the battery body 10 by means of a heat conductive adhesive, thereby ensuring good contact between the front plate 23 and the battery body 10, reducing the contact thermal resistance between the front plate 23 and the battery body 10, and enabling heat generated by the battery modules 11 to be conducted to the front plate 23 through the central thermally conductive plates 13 and to be dissipated.

In a possible implementation, the rear plate 24 is attached to the central thermally conductive plates 13 of the battery body 10 by means of the heat conductive adhesive, thereby ensuring good contact between the rear plate 24 and the battery body 10, reducing the contact thermal resistance between the rear plate 24 and the battery body 10, and enabling heat generated by the battery module 11 to be conducted to the rear plate 24 through the central thermally conductive plate 13 and to be dissipated.

In a possible implementation, referring to FIG. 1 and FIG. 6, since the two side surfaces of the battery body 10 are the side surfaces of the battery modules 11, the two side plates 22 are respectively attached to two side surfaces of the battery body 10 by means of the heat conductive adhesive, that is, the two side plates 22 are respectively attached to the first bent plate 114 of each heat conduction sheet 113 by means of the heat conductive adhesive, thereby ensuring a good thermal contact effect between the two side plates 22 and the battery modules 11, so that heat generated by the battery cell 111 could be conducted to the two side plates 22 through the first bent plate 114 of the heat conduction sheet 113, which dissipates the heat of the battery pack.

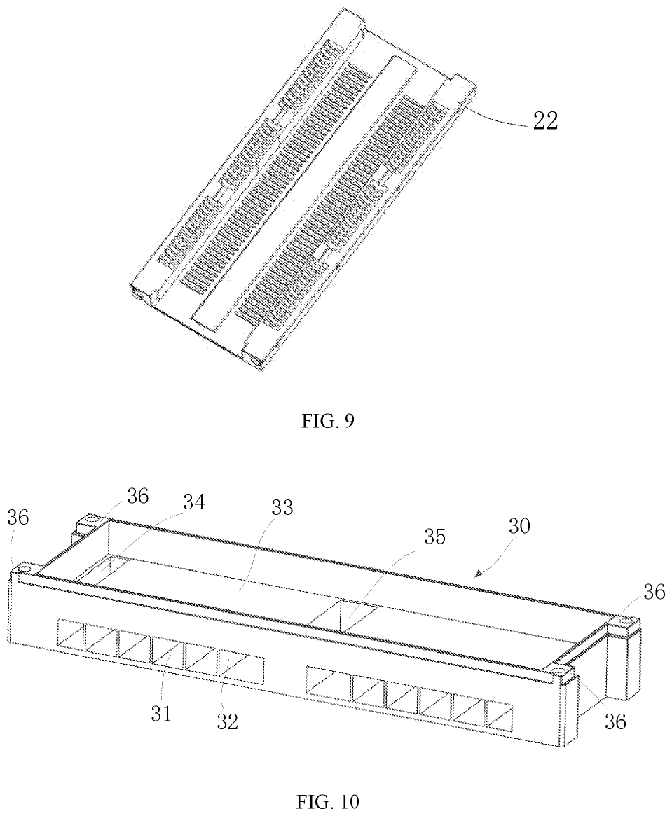

Referring to FIG. 1 and FIG. 9, the bottom plate 21 is provided with heat dissipation fins; and/or at least one of the two side plates 22 is provided with heat dissipation fins; and/or the front plate 23 is provided with heat dissipation fins; and/or the rear plate 24 is provided with heat dissipation fins.

In a possible implementation, the heat dissipation fins could be disposed on the bottom plate 21, the two side plates 22, the front plate 23 and the rear plate 24. The heat dissipation fins could increase the contact area with the outside, which ensures the heat dissipation capability of the bottom plate 21, the two side plates 22, the front plate 23 and the rear plate 24. The configurations and positions of the heat dissipation fins on the bottom plate 21, the two side plates 22, the front plate 23 and the rear plate 24 could be reasonably designed according to use requirements, which are not specifically limited here.

Referring to FIG. 1 and FIG. 8, one end of the bottom plate 21 is connected to the lower end of one side plate 22 through screws, the other end of the bottom plate 21 is connected to the lower end of the other side plate 22 through screws, the two sides of the front plate 23 are connected with the two side plates 22 through screws, and the two sides of the rear plate 24 are also connected with the two side plates 22 through screws.

The upper cover 40 is connected to the heat sink 30 through screws, the upper cover 40 could be provided with a switch button, one side of the upper cover 40 is provided with an interface 41, the interface 41 is connected with a battery management system in the heat sink 30, and the heat sink 30 could also dissipate heat for the battery management system and the interface 41 disposed in the heat sink 30.

Referring to FIG. 6 and FIG. 7, according to the battery pack provided by the embodiment of the present application, the assembly of the battery module 11 could be that the heat conduction sheet 113 is pasted on the outer side of the battery cell 111 by the heat conductive adhesive, and then the plurality of battery cells 111 are sequentially stacked side by side.

Referring to FIG. 5, the assembly process of the battery body 10 could be that the central thermally conductive plates 13 is disposed on the outer side of the assembled battery modules 11 respectively so that the battery modules 11 are disposed between the two side faces of the central thermally conductive plates 13, and then the two central thermally conductive plates 13 are oppositely placed with their bottoms bonded by means of heat conductive adhesive.

Referring to FIG. 1 and FIG. 8, the assembly process of the battery pack may include several steps. Firstly, bond the front surface of the battery body 10 with the front plate 23 by means of the heat conductive adhesive, and bond two side surfaces of the battery body 10 and the two side plates respectively 22 by means of the heat conductive adhesive, and connect the front plate 23 and the two side plates 22 by screws. Then bond the rear surface of the battery body 10 with the rear plate 24 by means of the heat conductive adhesive, and connect the rear plate 24 and the two side plates 22 by screws. Then connecting the bottom surface of the battery body 10 and the bottom plate 21 by means of the heat conductive adhesive, and then connect the bottom plate 21 and the two side plates 22 by screws. Finally, referring to FIG. 1 and FIG. 10, connect the upper ends of the two side plates 22 to a pair of mounting columns 36 of the heat sink 30 by screws. The way that firstly coat the heat conductive adhesive and then connect by screws, on one aspect, could ensure good heat conduction effect, and on the other aspect, could ensure the stability of the connection between the bottom plate 21, the two side plates 22, the front plate 23 and the rear plate 24.

The heat conductive adhesive is not limited to one or more of epoxy resin heat conductive adhesive, organic silicon heat conductive adhesive, polyurethane heat conductive adhesive or silicone adhesive.

According to the battery pack provided by the embodiment, heat dissipation of the battery body 10 and the tab 112 are both considered at the same time, which achieves good heat dissipation by not only utilizing the front surface, the rear surface, the bottom surface and the two side surfaces of the battery body 10, but also using the top of the battery body 10 to conduct heat. By conducting heat generated by the battery body 10 central outwards, conducting heat generated by the tab 112 upwards, and dissipating heat of the top of the battery body 10 via the heat sink 30, the heat dissipation effect of the battery pack is greatly improved, which improves the use safety of the battery pack and prolongs the service life of the battery pack.

According to the battery pack provided by the embodiment of the present application, the heat dissipation performance of the battery pack is improved, so that the temperature of the battery pack during high discharge rate work could be effectively reduced. The temperature of the battery pack could be reduced by 15° C. to 20° C. when tested at a discharging rate of 11.5 C and a charging rate of 7 C, charging and discharging time of 8 minutes, and cycles of 8 times, which is a remarkable effect of dissipation and cooling.

According to the battery pack provided by the embodiment of the application, the heat dissipation of the tabs 112 is considered, the heat generated by the tabs 112 and the heat conducted to the tabs 112 by the battery body 10 could be guiding outwards, and the temperature of the tabs 112 is effectively reduced. The temperature of the tabs 112 could be reduced by about 30° C. at a discharging rate of 11.5 C, a charging rate of 7 C, a charging and discharging time of 8 minutes and 8 cycles, which is a remarkable effect of dissipation and cooling.

The battery pack provided by the embodiment of the application ensures that it also has a low overall weight while having the heat dissipation structure. Taking a battery of 51.8 V and 29 Ah as an example, the overall weight of the battery pack could be limited within 11 kg, thus reducing the weight burden of the unmanned aerial vehicle while in operation.

It should be noted that the numerical value range and the numerical value range involved in the application are approximate values, the influence of the manufacturing process could have a certain range of errors, and the part of errors could be considered to be ignored by a person having ordinary skill in the art.

In the description of the present application, it should be understood that the used terms “center”, “length”, “width”, “thickness”, “top end”, “bottom end”, “upper”, “lower”, “left”, “right”, “front”, “rear”, “vertical”, “horizontal”, “inner”, “outer” “axial”, “circumferential” and the like are merely used to facilitate the description of the present application and the simplified description, rather than indicating or implying that the indicated position or original must have a specific orientation, and therefore, these terms could not be understood a limitation of the present application.

In addition, the terms “first” and “second” are only used for descriptive purposes, and could not be understood as indicating or implying relative importance or implicitly indicating the number of indicated technical features. Thus, features defined with “first” and “second” may explicitly or implicitly include one or more of the features. In the description of the present application, the meaning of “a plurality of” is at least two, for example, two, three, and the like, unless specifically defined otherwise.

In the present application, unless otherwise specified and limited, the terms “mounting”, “connected”, “connected”, “fixed” and the like should be broadly understood, for example, may be fixedly connected, or may be detachably connected or integrated; may be a mechanical connection or an electrical connection or may communicate with each other; and may be directly connected or indirectly connected by means of an intermediate medium, such that the communication between the interiors of the two elements or the interaction relationship between the two elements could be achieved. For a person having ordinary skill in the art, the specific meaning of the term in the present application could be understood according to specific situations.

In the present application, unless expressly specified and defined otherwise, the “upper” or “lower” of the first feature in the second feature may include direct contact of the first and second features, or may include that the first and second features are not in direct contact but are contacted by additional features there between. Moreover, the first feature is “above”, “above”, and “upper” of the second feature, including the first feature being directly above and obliquely above the second feature, or merely indicating that the first feature level is higher than the second feature. The first feature is “below”, “below” and “lower surface” of the second feature, and the first feature is directly below and obliquely below the second feature, or merely represents that the first feature horizontal height is less than the second feature.

Finally, the above embodiments are merely used to illustrate the technical solutions of the present application, rather than limiting the technical solutions of the present application. Although the present application has been described in detail with reference to the foregoing embodiments, it should be understood by a person having ordinary skill in the art that the present application could still modify the technical solutions recited in the foregoing embodiments, or equivalently replace some or all of the technical features. Moreover, these modifications or substitutions do not make the nature of the corresponding technical solutions separate from the scope of the technical solutions of the embodiments of the present application.

What is claimed is:

1. A battery pack, comprising:
a battery body;
a housing surrounding a part of a surface of the battery body; and
a heat sink, wherein a bottom surface of the heat sink abuts against a bus board disposed on an upper end of the battery body, and the heat sink is in thermal contact with a module electrode of the bus board.

2. The battery pack according to claim 1, wherein the battery pack further comprises a plurality of first thermally conductive pads, and the plurality of thermally conductive pads all abut between a lower surface of the bus board and the battery body.

3. The battery pack according to claim 1, wherein the bus board is provided with at least one second thermally conductive pad, an upper end of the battery body is provided with a tab, and the at least one second thermally conductive pad abuts between the tab and the heat sink.

4. The battery pack according to claim 3, wherein the battery body comprises at least two battery modules and at least two central thermally conductive plates correspondingly disposed on the outsides of the at least two battery modules.

5. The battery pack according to claim 4, wherein the central thermally conductive plate is U-shaped, the central thermally conductive plate surrounds at least three surfaces of the battery module, and an inner surface of the central thermally conductive plate is connected with the battery module by means of a heat conductive adhesive.

6. The battery pack according to claim 5, wherein the central thermally conductive plates between two adjacent battery modules in the at least two battery modules are oppositely disposed, and bottoms of the central thermally conductive plates between the two battery modules are connected by means of the heat conductive adhesive.

7. The battery pack according to claim 5, wherein the battery module comprises a plurality of battery cells and a plurality of heat conduction sheets respectively corresponding to the plurality of battery cells, the plurality of battery cells are stacked abreast, each of the heat conduction sheet surrounds at least three surfaces of the corresponding battery cell, and two adjacent heat conduction sheets in the plurality of heat conduction sheets are oppositely disposed.

8. The battery pack according to claim 7, wherein an elastic member is further provided between the two adjacent heat conduction sheets.

9. The battery pack according to claim 7, wherein the bus board is provided with a plurality of through slots in which a plurality of the second thermally conductive pads are embedded respectively, and the plurality of the second thermally conductive pads are respectively attached to a plurality of the tabs disposed at the upper ends of the plurality of battery cells.

10. The battery pack according to claim 1, wherein the battery pack further comprises an insulation plate disposed between the bus board and the heat sink, and a heat conducting medium is filled between the insulation plate and the bus board or between the insulation plate and the heat sink.

11. The battery pack according to claim 1, wherein an accommodation cavity for accommodating the battery body is enclosed in the housing, and the housing comprises:
a bottom plate disposed below the battery body;
a front plate disposed in front of the battery body;
a rear plate disposed behind the battery body; and
two side plates disposed on two sides of the battery body.

12. The battery pack according to claim 11, wherein the bottom plate is provided with a heat dissipation fin.

13. The battery pack according to claim 11, wherein at least one of the two side plates is provided with a heat dissipation fin.

14. The battery pack according to claim 11, wherein the front plate is provided with a heat dissipation fin.

15. The battery pack according to claim 11, wherein the rear plate is provided with a heat dissipation fin.

16. The battery pack according to claim 1, wherein the heat sink is disposed on the housing, and the heat sink is provided with a plurality of ventilation holes.

17. The battery pack according to claim 16, wherein the plurality of ventilation holes are in a side face of the heat sink and penetrate through two side faces of the heat sink.

18. The battery pack according to claim 16, wherein at least one of the ventilation holes is provided with at least one inner fin, and the inner fin extend along the extending direction of the ventilation hole.

19. The battery pack according to claim 16, wherein a top of the heat sink is provided with a concave cavity, the concave cavity is used for containing the battery management system, and a bottom of the concave cavity is adjacent to and isolated from a top of the ventilation hole.

20. The battery pack according to claim 1, wherein the battery pack further comprises an upper cover disposed on the heat sink, and the upper cover is provided with an interface.
